(19) United States
(12) Patent Application Publication
(10) Pub. No.: US 2004/0240648 A1
(43) Pub. Date: Dec. 2, 2004

(54) Dynamic processing of data processing instructions

(75) Inventors: Manfred Lilge, Berlin (DE); Thomas Ryll, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/792,274

(22) Filed: Mar. 4, 2004

(30) Foreign Application Priority Data
Mar. 5, 2003 (DE) 103 096 15.9

(51) Int. Cl. H04M 15/00

(52) U.S. Cl. 379/114.28

(57) ABSTRACT

A cost-effective and efficient way of dynamically processing data processing instructions is described by the method and the apparatus for dynamically processing at least one data processing instruction in a communication network, using a data processing system which is in a form such that it can process data processing instructions both in real time and in stack-oriented fashion, and at least one data processing instruction is processed in real time or in stack-oriented fashion depending on at least one input variable.

### CLAIM FOR PRIORITY

This application claims the benefit of priority to German Application No. 10309615.9, filed in the German language on Mar. 5, 2003, the contents of which are hereby incorporated by reference.

### TECHNICAL FIELD OF THE INVENTION

The invention relates to a method and an apparatus for dynamically processing at least one data processing instruction in a communication network.

### BACKGROUND OF THE INVENTION

In computer-aided electronic data processing, the processing speed is used as a criterion for determining the performance. For this purpose, the period of time, the response time, between the issuing of instructions by a user (man or machine) and the communication of the processing result to the latter is measured. The response time can be used to put electronic data processing systems (EDP systems) into two basic categories:

Real-time systems attempt to keep the response time as short as possible (<<1 sec.). This involves a high level of technical complexity which requires powerful hardware and software concepts.

Stack-oriented processing systems process a large number of instructions. In this case, a short response time is usually not necessary and can be up to several hours. The technical concepts clearly differ from those of the real-time systems.

The different implementation concepts are also reflected in their costs. The high level of technical complexity means that the costs for real-time systems are normally much higher than those for stack-oriented processing systems. Accordingly, a single instruction processed in real time is more expensive in terms of resources and costs than one in a stack-processing system.

The systems in both categories are justified on the basis of widely differing application scenarios. Thus, by way of example, various interfaces are used in each category which do not need to be supported in the respective other category.

However, the respective system strength is advantageous only if the application scenarios are homogeneous. A real-time system is efficient, by way of example, only if the instruction issuer is able to process a processing result obtained in real time further. All systems involved in an application scenario should be associated with the same basic category. A break within a processing chain either slows down a real-time scenario or speeds up a stack-oriented scenario unnecessarily.

Often, this desired homogeneity does not exist in scenarios with a large number of different instruction issuers. A solution which provides a plurality of different processing systems having the same functionality in order to be able to control any processing speed in optimum fashion is not desirable to the operators for cost reasons.

The data processing for application scenarios with different demands on the response time has previously been implemented:

either by providing different and functionally separate systems which control the respective application scenarios in optimum fashion,

or by also using real-time systems in application scenarios in which stack-oriented processing would have sufficed.

### SUMMARY OF THE INVENTION

The present invention discloses a dynamic method and a standard processing system for processing data processing instructions from various sources.

In one embodiment of the invention, there is a data processing system which is able to process data processing instructions both in real time and in stack-oriented fashion processes data processing instructions in real time or in stack-oriented fashion depending on an input variable. One advantage of the invention is that only one data processing system needs to be administered. Such a system represents a high measure of saving potential for the operator. The data processing system presented here can control (protocols and transport layers) a large number of existing interfaces which have been matched to the needs of the application scenarios (real time, stack-oriented etc.). This interface-specific usage allows the required response time to be recognized clearly. Methods for load limitation on interfaces in EDP systems already exist today. These are rigid, however, that is when a prescribed maximum bandwidth is reached on a particular interface no further instructions are accepted. The fixed assignment of the load upper limits for different interfaces may result in the situation that instructions can no longer be accepted via an interface IF1, even though as yet unused system resources are available on account of a lower load on a second interface IF2. The dynamic data processing allows the system resources to be automatically matched to requirements as appropriate during ongoing operation.

### BRIEF DESCRIPTION OF THE DRAWINGS

The invention is explained in more detail using exemplary embodiments which are illustrated in the figures, in which:

FIG. 1 shows a simplified flowchart for a dynamic data processing system.

FIG. 2 shows a network with an invoicing unit.

FIG. 3 shows a network with a Multimedia Messaging Center and an invoicing unit.

FIG. 4 shows a network with a plurality of services.

### DETAILED DESCRIPTION OF THE INVENTION

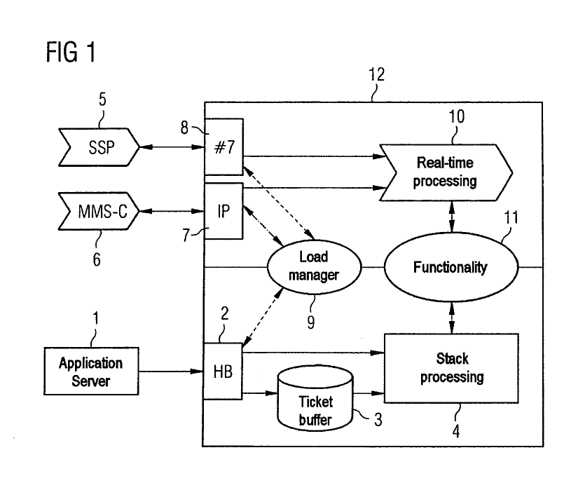

FIG. 1 shows a simplified flowchart for a dynamic data processing system 12 on the basis of an LoB enabling service which invoices for the use of IP and #7 services by mobile communication subscribers. Billing instructions can be sent to the EDP system 12 via different interfaces.

The dialog-oriented interfaces 2, 7, 9 which report back the processing result to the instruction issuer include the INAP/CAP-(SS-#7) protocol interface 8 and the radius (IP) interface 7. Stack-oriented processing instructions are sent to the system 12 via a ticket-based hot billing interface 2. Processing instructions can come from an application server 1, a Multimedia Messaging Center (MMS-C) 6, a storage service provider (SSP) 5 etc.

Regardless of the interface 2, 7, 9 used, the billing instructions are handled in an identical manner in terms of operation, however. A mobile communication subscriber is thus invoiced for the same sum regardless of which interface 2, 7, 9 is used to issue the instruction. The processing instructions differ in the processing speed: the SS-#7 and IP interfaces 9, 7 are controlled in real time, and the hot billing interface 2 is controlled in stack-oriented fashion. The software (protocol control program (protocol handler)) 11 controlling the respective interfaces 2, 7, 9 is configured such that it provides the billing instructions for the system-internal processing with an indicator which allows the corresponding instructions to be prioritized. This makes it possible to allocate the appropriate system resources in order to be able to process the instructions in real time 10 or in stack-oriented fashion 4. The protocol handler 11 is also responsible for monitoring the maximum load defined for an interface 2, 7, 9. If this load upper limit threatens to be exceeded, a central capacity manager (load manager) 9 can be used to request a higher load at the expense of the other interfaces 2, 7, 9. The capacity manager (load manager) 9 then redistributes the load between the interfaces 2, 7, 9 using a rule system. The interfaces 7, 9, which need to process instructions in real time 10, can have a higher priority for competing enquiries than stack-oriented interfaces 2, i.e. the maximum load is normally limited for the stack-oriented interfaces 2. The instructions accumulating on the hot billing interface 2 are collected in a ticket buffer 3 and are executed at times of low utilization (e.g. at night).

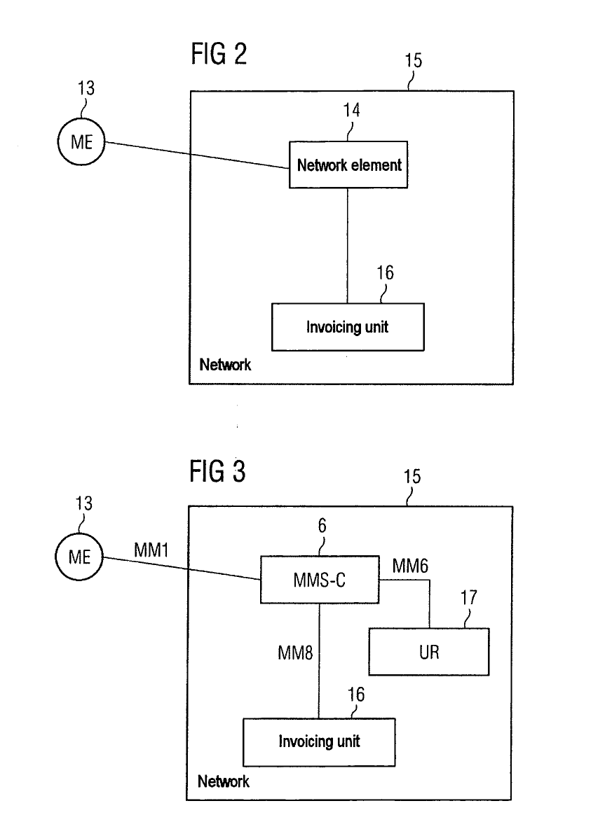

FIG. 2 shows a network 15 belonging to a network operator, which in this case is also the invoice issuer at the same time. It simultaneously operates a network element 14 providing a plurality of services (or one service, which inherently takes risk-related and less risk-related forms) which are used by a communication subscriber 13.

When billing for services/products particularly in telecommunication networks, the two payment methods of prepaid (credit account) and postpaid (invoicing) have been implemented.

Whereas the creditworthiness of a prepaid communication subscriber is of no importance to the service invoicer, since he has already received the appropriate payment from the communication subscriber prior to provision of the service/sale of the product or service, the situation is different for postpaid communication subscribers. In this case, the invoicer will have enquired about the subscriber's creditworthiness, so that he can assess the risk which he is taking with this subscriber.

From a technical point of view, the subdivision into prepaid and postpaid also has direct consequences, for example prepaid always involves the appropriate account funds being checked and a corresponding sum being reserved directly prior to provision of a service/sale of a product.

Such a check is not normally performed in the case of postpaid, but the invoicer grants the communication subscriber a credit facility and settles up with the communication subscriber usually on a monthly basis.

The appearance of new services specifically in the field of e/m-commerce and hence of greatly increasing sums per service/product means that a prior check may also become necessary for postpaid communication subscribers. In return, invoicers for prepaid communication subscribers are considering a more detailed distinction (e.g. per service provided/product sold) regarding whether and when a complex, and hence also cost-intensive (from the point of view of IT), prior check (e.g. for very small sums) is necessary.

The invoicer has divided the communication subscribers 13 into three classes of trust, namely those in whom he has a very level of trust (e.g. as a result of a long relationship without any payment problems), those with an average trust basis and those without any trust (e.g. in the case of a brand new relationship with the customer).

From this classification into communication-subscriber-specific classes of trust, the network operator can then derive the technical behavior, for example low-risk services and trustworthy communication subscribers will involve the use of a form of handling which is optimally tailored to such interests, “hot billing”. In this context, there is no check on a communication subscriber's account balance prior to provision of a service. Nor is billing effected in real time, but rather using an “offline” method. In the case of nontrustworthy communication subscribers 13, the network operator will use “online” means which allow coverage of the cost to be inspected prior to provision of a service. The online means can then be different for each service, for example a CAP-CAMEL application part (CAMEL=Customized Applications for Mobile Network Enhanced Logic) is available for a call. Other combinations need to be stipulated by the network operator on the basis of his commercial considerations.

The network operator can additionally put further rules on an invoicing unit 16, which allow even finer distinction. For example the nearing of a limit which has been stipulated by the invoicer, such as 5 euros, is monitored for each communication subscriber 13. Thus, if a prepaid account is still 5 EUR away from the natural limit of 0 EUR or else a postpaid account is still 5 EUR away from an upper credit limit (e.g. 100 EUR) stipulated by the network operator, the invoicing unit 16 can dynamically change the technical behavior and can now handle a communication subscriber 13, previously handled using offline means, using online means. A change in the opposite direction is also possible, for example by virtue of a prepaid communication subscriber 13 loading his account or a postpaid communication subscriber settling his invoice with the invoicer.

For billing purposes, the network element 14 addresses the invoicing unit 16, which also performs the pricing, inter alia.

Depending on the service to be provided, the network element 14, which the invoicing unit 16 sees as a client, can now apply various methods:

In the case of high-risk services or service forms, the network element 14 may decide that a real-time method needs to be applied in the communication with the invoicing unit 16. This “online” communication ensures that, prior to provision of a service, the invoicing unit 16 can check that the communication subscriber 13 is authorized to use the service (e.g. there are sufficient funds in the account). Only after a check by the invoicing unit 16 is the network element 14 notified that it needs to provide the risk-related service for the communication subscriber 13. In the case of less high-risk services, the network element 14 may decide that a non-real-time method (e.g. stack-oriented) needs to be applied in the communication with the invoicing unit 16. This “offline” communication involves the network element 14 providing the service for the communication subscriber 13 without any prior check on the authorization by the invoicing unit 16. The network element 14 merely generates a data record containing statements relating to the past service use by the communication subscriber 13. This data record is then forwarded using appropriate means (e.g. FTP/FTAM) to the invoicing unit 16, where billing is then effected.

Risk-related services may include, by way of example, “mobile commerce”, which covers the purchase of high-value products and therefore makes use of other technical means for account settlement so that lack of account funds in the case of prepaid or the exceeding of a limit in the case of postpaid subscribers is prevented. Low-risk services can be regarded as those which, by way of example, result in relatively small sums per transaction and hence present a relatively small risk for the invoicer. These include the Short Message Service (SMS), for example.

A distinction between prepaid and postpaid communication subscribers is not drawn, the only crucial factor is the connection with the service which is to be provided.

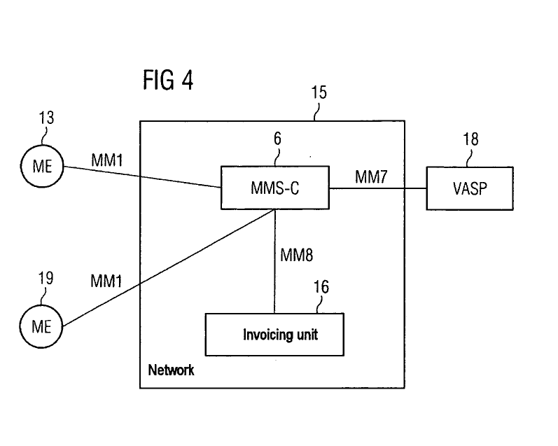

FIG. 3 shows a scenario in which a communication subscriber 13 with a mobile communication terminal 13 having MMS capability addresses the Multimedia Messaging Center 6 (MMS-C) . The communication subscriber 13 makes contact with the MMS-C 6. In the specification 3GPP TS 23.140 (Multimedia Messaging Service (MMS); Functional description; Stage 2), the interface used is identified by MM1. Either a sending or a fetching process for a multimedia message may be involved. In this example, it will be a sending process. Since sending an MMS incurs a charge, the MMS-C 6 needs to contact the invoicing unit 16 in order to initiate billing. So that it can use suitable technical means in order to do so, it effects read access to a central communication subscriber memory (User Repository—UR) 17 via the interface MM6, which contains information about how the invoicing unit needs to be contacted. The information in the UR 17 reveals that the MMS-C 6 needs to use the “hot billing” means, that is to say the communication with the invoicing unit 16 takes place “offline” via the interface MM8. The MMS-C 6 writes data which are relevant to the billing for this sending process to a file which is then evaluated by the invoicing unit 16. As soon as the file is available to the invoicing unit 16 (e.g. by FTP/FTAM), the invoicing unit 16 evaluates the information and determines the charge for the service. This sum is then debited from the subscriber's account. If, in this case, this billing process causes the account to fall below a limit value (e.g. 5 EUR) stipulated by the network operator, and the communication subscriber 13 is a prepaid communication subscriber, the invoicing unit 16 notifies the UR (e.g. including by means of Lightweight Directory Access Protocol—LDAP) that the type of billing mechanism needs to be changed for the communication subscriber 13. The communication subscriber 13 is then changed to “online”. The next time a service is used for which there is a charge, the MMS-C 6 will effect the billing with the invoicing unit 16 using “online” means.

FIG. 4 shows a scenario with a low-risk service form and a high-risk service form of the Multimedia Messaging Service (MMS). The Multimedia Messaging Service is part of the 3^{rd} Generation Partnership Project and is described in the aforementioned specification 3GPP TS 23.140.

Low-risk Service Form:

The communication subscriber with a communication terminal 13 contacts the Multimedia Messaging Center (MMS-C) 6; in the aforementioned specification, the interface is identified by MM1. Either a sending or a fetching process for a multimedia message may be involved. In this example, a message will be sent to another communication subscriber with a communication terminal 19. The MMS-C 6 holds the information that messages from one communication subscriber to another using a communication terminal are classified as low risk. Accordingly, the MMS-C 6 can apply an offline method of billing and can deliver the message without further communication with the invoicing unit 16. Billing is effected by recording all the relevant data for transmission of this message in a data record (“ticket”) which is delivered with a time delay via the interface MM8 to the invoicing unit 16 for further billing. The transport can be effected by FTP/FTAM.

High-risk Service Form:

A Value Added Service Provider (VASP) 18 addresses the MMS-C 6 via the interface MM7 for the purpose of sending a multimedia message. The content is tailored specifically to the communication subscriber 19 and includes important information for him (19), that is valuable information. The MMS-C 6 holds the information that messages in this class from this particular VASP 18 are to be regarded as high risk, that is, prior to sending, it is necessary to contact the invoicing unit 16, which is done using online means using the interface MM8. Following successful authorization of the transaction by the invoicing unit 16 and acknowledgement to the MMS-C 6, the message can be sent to the communication subscriber 19 via the interface MM1. In this example, the communication subscriber 19 is billed. Successful delivery is reported to the invoicing unit 16 by the MMS-C 6, and the invoicing unit 16 then concludes the financial transaction for the communication subscriber 19.

What is claimed is:

1. A method for dynamically processing at least one data processing instruction in a communication network, comprising:
providing a data processing system which is configured to process data processing instructions in real time and in stack-oriented fashion; and
processing at least one data processing instruction in real time or in stack-oriented fashion depending on at least one input variable.

2. The method as claimed in claim 1, wherein the input variable used is information about priority of the data processing instruction which is to be processed.

3. The method as claimed in claim 1, wherein the input variable used is information about the processing speed which is to be used.

4. The method as claimed in claim 1, wherein the input variable used is information about the interface used by a subscriber.

5. The method as claimed in claim 1, wherein the input variable used is information about the bandwidth of the respective interface.

6. A method for billing for services provided for a communication subscriber in a communication network, comprising:
entering into a memory at least one rule relating to a type and time of the billing for a service which is to be provided for at least one communication subscriber;
prompting at least one entered rule to be checked by an invoicing unit as a result of an enquiry from a communication subscriber regarding the provision of a service; and
effecting the billing for the provided service on a rule-dependent basis.

7. The method as claimed in claim 6, wherein the billing is effected on a rule-dependent basis for a credit account.

8. The method as claimed in claim 6, wherein the billing is effected on a rule-dependent basis at a particular time.

9. The method as claimed in claim 6, wherein the billing is effected on a rule-dependent basis on strength of a classification for services into risk groups.

10. The method as claimed in claim 6, wherein an INAP/CAP protocol and/or a radius IP interface is/are used.

11. The method as claimed in claim 6, wherein the billing is effected on a rule-dependent basis for a statement relating to trustworthiness of a telecommunication subscriber.

12. The method as claimed in claim 6, wherein a network operator enters at least one rule for the at least one communication subscriber in the memory.

13. An apparatus for billing for services provided for a communication subscriber in a communication network, comprising:
a memory to enter at least one rule relating to a type and time of the billing for a service which is to be provided for at least one communication subscriber;
a reception unit in an invoicing unit to receive an enquiry regarding the billing for a service which is to be provided;
a processing unit to check the memory for the at least one rule and for effecting the billing on a rule-dependent basis; and
a transmission unit to forward the billing result to further network units.
